(19) United States
(12) Patent Application Publication
(10) Pub. No.: US 2026/0368213 A1
(43) Pub. Date: Nov. 19, 2026

(54) SYSTEMS AND METHODS FOR SECURED ARCHIVING AND RETRIEVAL IN MIXED-DOMAIN COMPUTER NETWORKS

(71) Applicant: Capital One Services, LLC, McLean, VA (US)

(72) Inventors: Zhongrun XIANG, North Potomac, MD (US); Molly PIERCE, Arlington, VA (US); Zhuolin LUO, Long Island City, NY (US); Stephen TANG, Falls Church, VA (US); Bozhao TAN, Sunnyvale, CA (US)

(73) Assignee: Capital One Services, LLC, McLean, VA (US)

(21) Appl. No.: 19/679,466

(22) Filed: May 15, 2026

Related U.S. Application Data
(60) Provisional application No. 63/806,573, filed on May 15, 2025.

(51) Int. Cl. G06F 16/332; G06F 16/335

(52) U.S. Cl. CPC G06F 16/3322; G06F 16/335

(57) ABSTRACT

Systems and methods for improved archiving and retrieval of computer records in mixed-domain computer networks. More specifically, the systems and methods achieve these improvements by increasing record identifiers (e.g., acronyms, abbreviations, and blended words) by expanding the amount of record identifiers organically based on existing native record identifiers. For example, the native identifier expansion leverages actual usage patterns, such as how users coin shorthand terms or how certain blended words evolve organically in internal communication or logs. These emergent terms often follow domain-specific conventions that are invisible to external sources. Capturing and reusing these native patterns supports semantic coherence, making the overall system more intelligible, searchable, and usable.

### CROSS-REFERENCE TO RELATED APPLICATIONS

This application claims the benefit of priority of U.S. Provisional Application No. 63/806,573, filed May 15, 2025. The content of the foregoing application is incorporated herein in its entirety by reference.

### BACKGROUND

Storing network data in a common database that is archived based on acronyms, abbreviations, and blended words in the network data (and/or its metadata) presents significant technical challenges due to ambiguity, inconsistency, and domain-specific language. One of the primary difficulties lies in the ambiguous nature of shortened terms. Acronyms like “IP” may mean “Internet Protocol,” “Intellectual Property,” or “Ingress Protection,” depending on the context. Abbreviations are inherently lossy, as they strip away essential contextual information, e.g., “ML” could stand for “Machine Learning,” “Maximum Likelihood,” or “Markup Language.” Blended words such as “netsec” (for network security) are often informal and lack standardized formation rules, making them difficult to parse or recognize programmatically.

This technical problem is further compounded by the fact that network data typically spans multiple domains, including systems administration, cybersecurity, cloud infrastructure, and software engineering, each of which has its own specialized jargon. These domains often use overlapping or conflicting abbreviations, and there is no centralized registry to define or govern the use of acronyms across them. As a result, designing consistent indexing, classification, and retrieval systems becomes extremely difficult. Moreover, as these multiple domains are required to be maintained in a secure state, there are fewer options for mitigating the specialized jargon through knowledge sharing.

Another technical problem is the instability of metadata over time. Acronyms and abbreviations may evolve: new ones emerge as technologies develop, e.g., such as “SASE” or “XDR”, while older ones may be repurposed or fall out of use. For instance, “AI” might have referred to “App Integration” in a specific context in the past, but is now commonly understood as “Artificial Intelligence.” If a database relies on these unstable terms for archival, the metadata may become outdated or misleading, undermining the long-term utility of the stored data.

### SUMMARY

Systems and methods are described herein for novel uses and/or improvements to computer networks that archive content across domains. As one example, systems and methods are described herein for improved archiving and retrieval of computer records in mixed-domain computer networks. More specifically, the systems and methods achieve these improvements by increasing record identifiers (e.g., acronyms, abbreviations, and blended words) by expanding the amount of record identifiers organically based on existing native record identifiers. Notably, in contrast to this approach, conventional approaches attempt to expand record identifiers based on non-native record identifiers. That is, as opposed to growing the known record identifiers using existing native record identifiers, conventional approaches attempt to expand the amount of non-native record identifiers that may be used.

For example, conventional approaches that attempt to expand the internal lexicon by searching non-native sources, e.g., such as public dictionaries, acronym registries, or open word databases, introduce a high degree of lexical noise and irrelevant terms. These repositories may include terms that are linguistically valid but semantically foreign or ambiguous in the system’s domain. For example, pulling in “IP” from a general acronym database might include “Investment Plan” or “Initial Point,” neither of which is relevant in a networking or IT context. This influx of out-of-context terms not only pollutes the metadata but also introduces significant disambiguation overhead, requiring additional logic or human intervention to filter out or correct the mismatches.

In contrast, native identifier expansion leverages actual usage patterns, such as how users coin shorthand terms or how certain blended words evolve organically in internal communication or logs. These emergent terms often follow domain-specific conventions that are invisible to external sources. Capturing and reusing these native patterns supports semantic coherence, making the overall system more intelligible, searchable, and usable. It also aids in incremental learning, e.g., the system may adapt to changes in language and concept drift within the organization without manual curation or retraining from scratch.

The systems and methods system may overcome the limitations of conventional approaches to record identifier expansion by implementing a prompt-driven, context-aware model pipeline that integrates native semantics with external lexical enrichment while preserving domain fidelity. This process begins by generating a first prompt for a language model, where the prompt is constructed using a native record identifier (e.g., an acronym or abbreviation) and its local context, such as its usage in logs, metadata, or documentation. This contextualization anchors the model’s interpretation of the identifier, reducing ambiguity and guiding the model toward domain-relevant expansions.

Using this context-rich prompt, a first model (such as a domain-tuned large language model) generates a non-native record identifier, e.g., an expanded or related term not currently present in the native dataset. This expansion reflects how the identifier might semantically evolve or be expressed in broader technical literature or adjacent domains. However, rather than directly adopting this non-native identifier into the internal lexicon, the system performs a semantic comparison between the generated non-native identifier and a plurality of existing native record identifiers. This comparison may involve embedding similarity, contextual overlap, or pattern matching to assess alignment.

Based on this comparison, the system generates a recommendation indicating whether the non-native identifier should be considered a valid expansion of the original native identifier. The recommendation may include a confidence score or a categorical label (e.g., “valid expansion,” “ambiguous,” or “irrelevant”) to guide downstream integration. This closed-loop verification process ensures that only contextually coherent and semantically aligned expansions are incorporated, preserving domain consistency while leveraging external knowledge sources. In doing so, the system blends the strengths of native and non-native approaches, enabling intelligent, scalable, and context-aware identifier growth without the noise and semantic mismatch typical of conventional methods.

In some aspects, systems and methods for record identifier expansion based on non-native record identifiers are described. For example, the system may receive native domain data, wherein the native domain data comprise a plurality of character strings. The system may parse the native domain data to receive a native record identifier corresponding to a character string of the plurality of character strings. The system may generate a first prompt, for a first model, based on the native record identifier and a context for the native record identifier. The system may generate a non-native record identifier based on the first prompt, wherein the non-native record identifier corresponds to a potential expansion of the native record identifier. The system may compare the non-native record identifier to a plurality of native record identifiers to generate a recommendation for the non-native record identifier, wherein the recommendation indicates whether the non-native record identifier corresponds to an expansion of the native record identifier. The system may generate, for display on a user interface, the recommendation.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a four-step framework for expanding native record identifiers, in accordance with one or more embodiments.

FIG. 2 shows an illustrative diagram for prompts for expanding native record identifiers, in accordance with one or more embodiments.

FIG. 3 shows illustrative components for a system involved in record identifier expansion, in accordance with one or more embodiments.

FIG. 4 shows a flowchart of the steps involved in record identifier expansion based on non-native record identifiers, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Systems and methods are described herein for novel uses and/or improvements to computer networks that archive content across domains. As one example, systems and methods are described herein for improved archiving and retrieval of computer records in mixed-domain computer networks. More specifically, the systems and methods achieve these improvements by increasing record identifiers (e.g., acronyms, abbreviations, and blended words) by expanding the amount of record identifiers organically based on existing native record identifiers. Notably, in contrast to this approach, conventional approaches attempt to expand record identifiers based on non-native record identifiers. That is, as opposed to growing the known record identifiers using existing native record identifiers, conventional approaches attempt to expand the amount of non-native record identifiers that may be used.

For example, it is technically more efficient to increase record identifiers, e.g., such as acronyms, abbreviations, and blended words, by expanding them organically from existing native record identifiers rather than relying on non-native sources like public word databases or generic lexicons. The core reason lies in the alignment of context, semantics, and usage patterns within the native dataset, which enables more accurate, relevant, and scalable identifier expansion.

When record identifiers are grown organically from existing native data, they are inherently contextualized within the specific domain or system. For instance, if a dataset from a cybersecurity platform frequently uses “IDS” (Intrusion Detection System), organically derived expansions like “IPS” (Intrusion Prevention System) or “SIEM” (Security Information and Event Management) are far more likely to reflect authentic, meaningful extensions of the existing lexicon. These identifiers are grounded in the same operational, linguistic, and technical environment as the original data, preserving domain integrity and minimizing semantic drift. This leads to higher precision in retrieval, indexing, classification, and tagging, as the identifiers resonate with how information is actually used by the system and its users.

In contrast, conventional approaches that attempt to expand the internal lexicon by searching non-native sources, e.g., such as public dictionaries, acronym registries, or open word databases, introduce a high degree of lexical noise and irrelevant terms. These repositories may include terms that are linguistically valid but semantically foreign or ambiguous in the system’s domain. For example, pulling in “IP” from a general acronym database might include “Investment Plan” or “Initial Point,” neither of which is relevant in a networking or IT context. This influx of out-of-context terms not only pollutes the metadata but also introduces significant disambiguation overhead, requiring additional logic or human intervention to filter out or correct the mismatches.

Furthermore, native identifier expansion leverages actual usage patterns, such as how users coin shorthand terms or how certain blended words evolve organically in internal communication or logs. These emergent terms often follow domain-specific conventions that are invisible to external sources. Capturing and reusing these native patterns supports semantic coherence, making the overall system more intelligible, searchable, and usable. It also aids in incremental learning, e.g., the system may adapt to changes in language and concept drift within the organization without manual curation or retraining from scratch.

From a systems engineering perspective, relying on native expansion is more computationally efficient. It avoids the need for massive external queries, alignment heuristics, or mapping engines required to reconcile non-native terms. It also reduces false positives in entity recognition, lowers index bloat, and improves retrieval precision, since the expanded terms are more tightly coupled to the domain’s operational vocabulary.

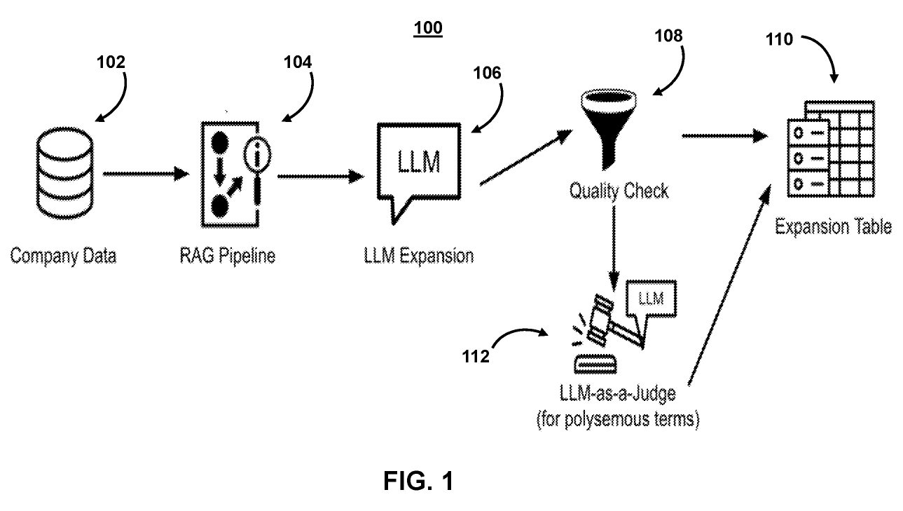

FIG. 1 shows an illustrative diagram for a four-step framework for expanding native record identifiers, e.g., such as acronyms, abbreviations, or blended words, within internal datasets using a retrieval-augmented generation (RAG) approach enhanced by large language models (LLMs), in accordance with one or more embodiments. The process begins at a first step at which data 102 (e.g., company-specific data) is ingested. This data may include structured and unstructured content such as dataset titles, column names, descriptions, and internal documentation. For example, system 100 may receive data 102 (e.g., comprising a native record identifier) and input data 102 into pipeline 104 (e.g., a RAG-based model). An output of pipeline 104 may comprise record identifier expansion 106 (e.g., a non-native record identifier) that may then be subjected to quality check 108, which may be supplemented by an output from model 112, prior to being recommended as an expansion of the native record identifier and entered into expansion table 110.

At a second step, data 102 is then passed through a RAG pipeline (e.g., pipeline 104). For example, the system may process data 102 through a RAG pipeline by first identifying candidate abbreviations and acronyms using a lexical filtering step. This step employs a predefined word list, e.g., the Oxford 3000 word list, to distinguish uncommon or domain-specific tokens that are likely to be abbreviations. Any term in the dataset that does not appear in the Oxford 3000 list is flagged as a potential abbreviation or acronym. This filtering helps reduce false positives and narrows the focus to tokens with a higher probability of being domain-specific short forms. Once candidate abbreviations are identified, the pipeline may construct structured prompts that incorporate both the term itself and its surrounding context (e.g., paragraph level descriptions and/or column metadata). For unstructured data, this context may consist of the full sentence or paragraph where the term appears. For structured datasets, such as databases or spreadsheets, the pipeline uses available metadata, e.g., such as the column name or column description, to provide contextual clues. For example, if the dataset includes a column titled AGG_SCORE_FOR_RL with the description “This column represents the aggregation score of risk level,” the system extracts “AGG” and “RL” as target terms and packages them with the descriptive sentence. This combined input is then formatted into a structured prompt for the LLM, which is instructed to generate possible expansions for each abbreviation using the contextual information. The resulting prompt serves as a precise and domain-grounded query, enabling the language model to produce more accurate and semantically aligned expansions. This method leverages both lexical exclusion and contextual grounding, which together form the core strengths of the RAG pipeline in abbreviation expansion.

At a next step, system 100 receives record identifier expansion 106. For example, the system may generate a candidate expansion for each abbreviation using an LLM. This initial expansion may not be automatically accepted; instead, it may undergo quality check 108. The quality check filters out spurious expansions, such as cases where the expanded term is identical to the original abbreviation (e.g., “cyber” → “cyber”), or where the output is simply a token-split of the original term (e.g., “tradecount” → “trade count”), or is clearly a misspelling. Furthermore, a frequency-based rule assesses whether expanded forms appear meaningfully in the dataset, to avoid introducing rarely used or confusing full-form terms.

An additional evaluation layer is provided by a second LLM (e.g., model 112), which acts as a semantic judge. This “LLM-as-a-Judge” stage addresses ambiguity in polysemous or multi-meaning terms by consolidating semantically equivalent expansions or associating different meanings with relevant contextual keywords. For example, the term “LTD” could mean “Life To Date,” “Long Term Disability,” “Long Term Debt,” or “Limited,” depending on the data context; the LLM judge resolves such ambiguity by associating each meaning with key contextual cues.

Finally, after passing these quality and disambiguation checks, validated expansions are stored in the expansion table 110. This table serves as a persistent and continuously enriched lexicon of validated record identifier expansions, supporting improved interpretability for both human users and downstream automated systems.

In some embodiments, system 100 may implement the four-step framework within secured computer network domains by first accessing one or more of these domains, each comprising a plurality of encrypted character strings. These encrypted strings may represent obfuscated or tokenized identifiers used in protected datasets, ensuring compliance with security policies and data privacy constraints. The system parses the secured domains to extract an encrypted computer network identifier, which is a specific character string representing a potentially abbreviated or obfuscated reference to a network-related concept. In parallel, the system retrieves contextual information associated with the identifier, such as surrounding metadata, log file descriptions, or column-level annotations, which are also securely stored and processed.

Using the extracted identifier and its associated context, the system generates a first prompt for a first model, e.g., typically a retrieval-augmented large language model (RAG-LLM). This prompt is engineered to instruct the model to produce a non-encrypted computer network identifier, which represents a plausible semantic expansion or interpretation of the original encrypted string. For example, an encrypted identifier like “RL” might be hypothesized by the model to represent “risk level,” based on its contextual use. Once this candidate expansion is generated, the system compares the resulting non-encrypted identifier to a plurality of encrypted computer network identifiers already present in the domain. This step ensures alignment with pre-existing knowledge and performs a filtering function to detect inconsistencies, duplicates, or false positives. If the comparison step determines that the non-encrypted candidate is not to be filtered out, e.g., that is, it is novel and plausibly valid, the system proceeds to evaluate its semantic quality.

At this point, the system constructs a second prompt for a second model, e.g., an LLM acting as a semantic judge. This second-stage model assesses the ambiguity of the proposed non-encrypted identifier by considering its potential for multiple interpretations across different contexts. The model is instructed to determine whether the candidate expansion is semantically stable, overly general, or polysemous, and may annotate the identifier with disambiguating keywords, examples, or confidence metrics. Based on this ambiguity assessment, the system generates a recommendation for display on a user interface. This recommendation indicates whether the candidate non-encrypted identifier is likely to be a valid, useful expansion of the encrypted identifier and whether it should be accepted, flagged for review, or discarded. Through this secure, multi-stage process, system 100 may intelligently expand and interpret network-specific encrypted identifiers while preserving data integrity, semantic accuracy, and operational confidentiality.

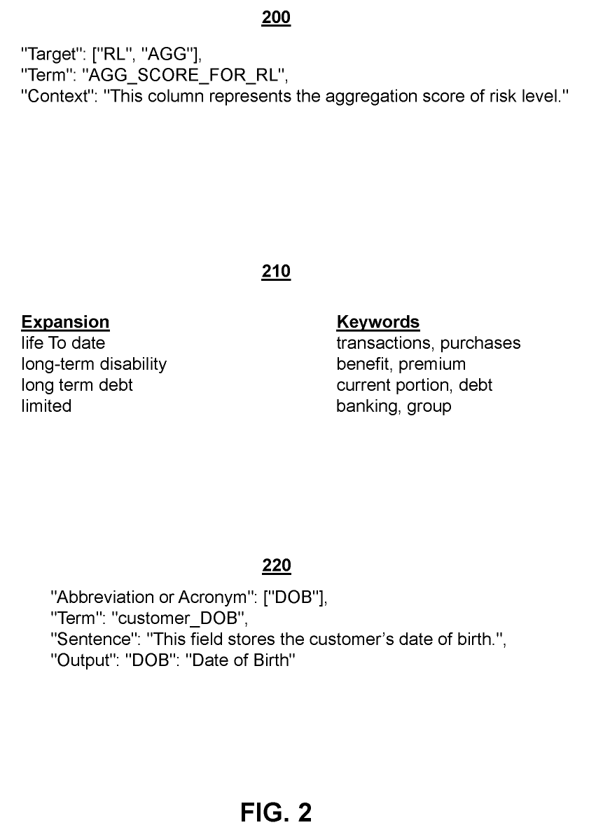

FIG. 2 shows an illustrative diagram for prompts for expanding native record identifiers, in accordance with one or more embodiments. For example, FIG. 2 includes prompt 200, which may comprise an input to a model to generate a native record identifier expansion. FIG. 2 also includes table 210, which includes extracted keywords from the content of a prompt used to disambiguating the term “LTD”. Finally, FIG. 2 includes example 220, which comprises a result, in a JSON format, of an abbreviation and its potential expansion.

FIG. 2 illustrates concrete components of the abbreviation and acronym expansion framework introduced in the system, highlighting how native and ambiguous record identifiers are processed using structured prompts and semantic evaluation. At the top, prompt 200 represents a sample input to a language model. This prompt comprises a list of target abbreviations (“RL” and “AGG”), a source term (“AGG_SCORE_FOR_RL”), and a contextual description (“This column represents the aggregation score of risk level”). This prompt would be submitted to the first LLM in the pipeline for generating candidate expansions of the abbreviations, using the context to improve semantic accuracy.

Next, table 210 showcases the outcome of the second-stage semantic disambiguation performed by the LLM-as-a-Judge. The table pairs ambiguous expansions of the abbreviation “LTD” with contextual keywords that the second model extracted to help differentiate their meanings. For instance, “life to date” is associated with “transactions” and “purchases,” while “long-term disability” is linked to “benefit” and “premium.” This demonstrates how the model distinguishes between polysemous terms based on contextual patterns, a key component of the framework’s fourth step for resolving ambiguity and improving clarity in internal lexicons.

Lastly, example 220 provides a complete and clean output of the abbreviation expansion process in JSON format. It shows a term “customer_DOB” with the abbreviation “DOB,” contextualized by the sentence “This field stores the customer’s date of birth.” The model correctly expands “DOB” to “Date of Birth” and returns the result in a structured output. This example illustrates a straightforward case where the abbreviation is well-supported by its context and easily disambiguated by the LLM. Together, the elements in FIG. 2 provide a practical view of how the system transitions from context-aware prompt construction through disambiguation and final output generation, encapsulating the logic of both native identifier expansion and ambiguity resolution.

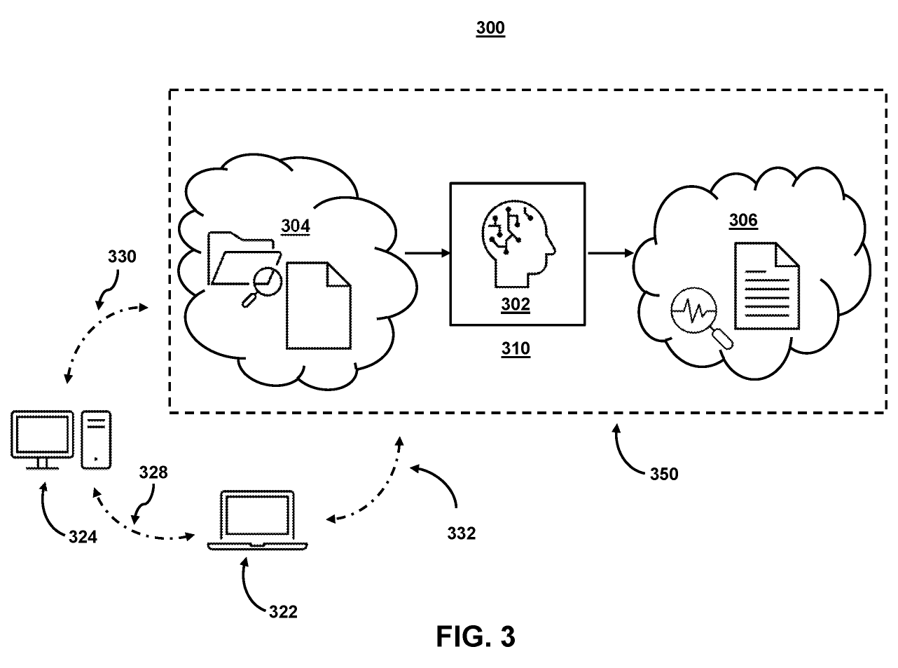

FIG. 3 shows illustrative components for a system involved in record identifier expansion, in accordance with one or more embodiments. For example, FIG. 3 may show illustrative components for secured archiving and retrieval in mixed-domain computer networks. As shown in FIG. 3, system 300 may include device 322 and user terminal 324. While shown as a laptop computer and personal computer, respectively, in FIG. 3, it should be noted that device 322 and user terminal 324 may be any computing device, including, but not limited to, a smartphone, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both device 322 and user terminal 324 include a display upon which to display data (e.g., conversational response, queries, and/or notifications).

It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits may be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality may be complex and time-consuming. Additionally, data that is obtained may need to be categorized and labeled accurately, which may be a difficult, time-consuming manual task. Second, despite the mainstream popularity of artificial intelligence, practical implementations of artificial intelligence may require specialized knowledge to design, program, and integrate artificial intelligence-based solutions, which may limit the amount of people and resources available to create these practical implementations. Finally, results based on artificial intelligence may be difficult to review, as the process by which the results are made may be unknown or obscured. This obscurity may create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an expansion, an ambiguity, a similarity between record identifiers, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model model 302 is a neural network, connection weights may be adjusted to reconcile differences between the neural network’s prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections may be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and may perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an expansion, an ambiguity, a similarity between record identifiers, etc.).

In some embodiments, the model (e.g., model 302) may automatically perform actions based on outputs 306. In some embodiments, the model (e.g., model 302) may not perform any actions. The output of the model (e.g., model 302) may be used to determine an expansion, an ambiguity, a similarity between record identifiers, etc.

In some embodiments, the system may expand record identifiers (e.g., acronyms) by orchestrating multiple models in a pipeline. First, the system generates a first prompt for a first model using the native record identifier and contextual information associated with that identifier (for example, surrounding text, record metadata, domain, source application, or nearby fields). Using this prompt, the first model produces a non-native record identifier that represents a candidate expansion of the native record identifier (e.g., expanding an acronym into a full phrase). The system then evaluates this candidate by comparing the non-native record identifier against a plurality of native record identifiers (and/or their known expansions) using one or more additional models or matching techniques (such as embedding similarity, lexical alignment, classifier-based verification, or rules). Based on these comparisons, the system generates a recommendation indicating whether the non-native record identifier is a valid expansion of the native record identifier (and optionally provides a confidence score, ranking, or explanation for the determination).

The system may use different model algorithms at various stages of record-identifier expansion. For generation of candidate expansions, it may use a sequence-to-sequence transformer (e.g., encoder–decoder or instruction-tuned LLM) that conditions on the native identifier plus context to produce likely long-form expansions, or a masked-language model that fills expansion templates based on surrounding text. For normalization and candidate retrieval, it may use dual-encoder (bi-encoder) embedding models (e.g., sentence transformers) to map identifiers and candidate expansions into a shared vector space for nearest-neighbor search, optionally backed by approximate nearest neighbor indexing. For validation and recommendation, it may use a cross-encoder transformer that jointly encodes the native identifier, context, and candidate expansion to output a match probability, or a supervised classifier (e.g., gradient-boosted decision trees or logistic regression) over engineered features such as character-level similarity, token overlap, acronym-letter alignment, edit distance, and contextual co-occurrence signals. In domain-specific settings, it may use graph-based algorithms over an ontology or knowledge graph (e.g., link prediction or random-walk scoring) to ensure the expansion is consistent with known entity relationships, and it may incorporate Bayesian or calibrated scoring models to combine multiple signals into a single confidence-weighted recommendation.

Using different model algorithms provides complementary technical benefits across the expansion workflow. Generative transformer models (seq2seq or instruction-tuned LLMs) may synthesize plausible, context-sensitive expansions even when an acronym is ambiguous or previously unseen, reducing dependence on precompiled dictionaries. Masked-language models and template-based fill strategies may be more constrained and predictable, improving controllability and lowering the risk of irrelevant outputs. Dual-encoder embedding models enable efficient large-scale retrieval by precomputing vectors for many candidate identifiers/expansions and performing fast nearest-neighbor search, which improves latency and scalability while capturing semantic similarity beyond exact string matches. Cross-encoder models, which jointly evaluate the native identifier, context, and candidate expansion, typically deliver higher precision because they model fine-grained interactions between tokens, making them well-suited for final verification and confidence scoring. Lightweight supervised classifiers (e.g., logistic regression or gradient-boosted trees) over lexical and acronym-alignment features are fast, interpretable, and easier to calibrate, and they may provide stable performance when training data is limited or when explainability is required. Graph/ontology-based methods add consistency checks against known entity relationships and domain constraints, helping prevent expansions that are semantically incompatible with the surrounding record or organizational taxonomy. Finally, ensemble or calibrated fusion approaches combine these complementary signals to improve robustness, e.g., maintaining recall from generative/retrieval models while achieving higher precision and better confidence estimation through discriminative verification.

When generating and recommending record-identifier expansions, the system may use multiple model algorithms with distinct inputs and outputs. A generative transformer (seq2seq/LLM) may take as input the native record identifier (e.g., “API”), optional surrounding text, and structured context such as record type, field name, domain labels, and neighboring values, and outputs one or more non-native record identifiers as free-text candidate expansions (often with optional logits, token-level probabilities, or multiple ranked beams). A masked-language model may take an input sentence or template containing the native identifier and a mask or placeholder (e.g., “API stands for [MASK]”), and outputs one or more filled expansions with associated likelihood scores. A dual-encoder embedding model may take as input the native identifier (and possibly its context) and separately takes as input each candidate expansion or reference identifier; it outputs vector embeddings that enable similarity scores and a ranked list of nearest candidates, often used to retrieve plausible expansions from a catalog. A cross-encoder verifier takes as input a paired or triplet representation (e.g., native identifier + context, candidate expansion) and outputs a scalar match probability or relevance score indicating whether the candidate is a valid expansion, sometimes alongside a calibrated confidence. A feature-based classifier (e.g., logistic regression or gradient-boosted trees) may take as input engineered features derived from the native identifier, context, and candidate (such as edit distance, acronym-letter alignment, token overlap, and embedding similarities) and outputs a binary decision and/or probability. If a knowledge-graph or ontology model is used, the system may take as input the native identifier, candidate expansion, and graph neighborhood (types, relations, synonyms) and outputs constraint-satisfaction results, link-prediction scores, or a validated canonical entity identifier, which the system may emit as the final recommended expansion and confidence.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that may improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant’s likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

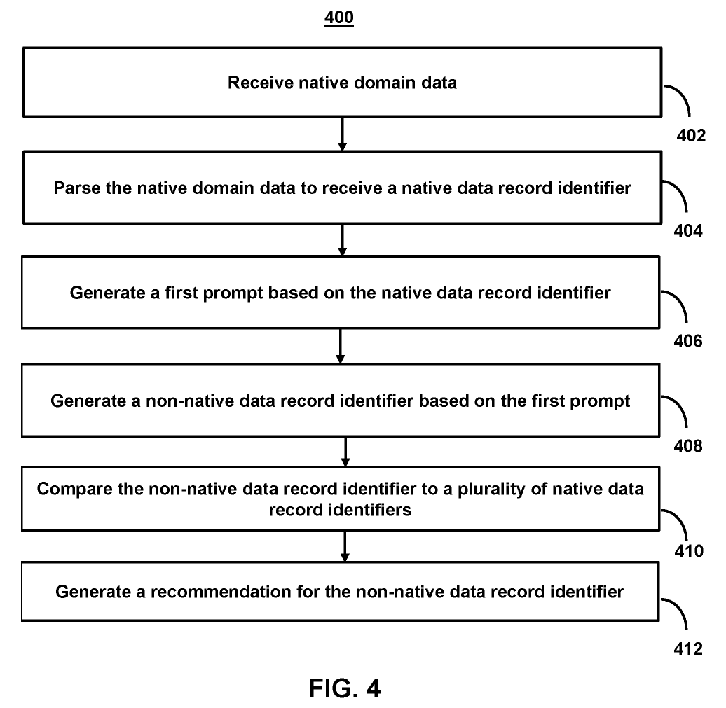

FIG. 4 shows a flowchart of the steps involved in record identifier expansion based on non-native record identifiers, in accordance with one or more embodiments. For example, the system may use process 400 (e.g., as implemented on one or more system components described above) in order to provide secured archiving and retrieval in mixed-domain computer networks.

At step 402, process 400 (e.g., using one or more components described above) receives native domain data. For example, the system may receive native domain data, wherein the native domain data comprise a plurality of character strings. The system may receive native domain data by ingesting input from one or more internal sources that contain a plurality of character strings representative of domain-specific content. These character strings may originate from structured data, such as database tables, column names, and configuration files, or from unstructured sources, including internal documents, logs, web interfaces, or descriptive metadata. The system may access this data via secure data pipelines, APIs, or batch processing mechanisms, depending on the architecture and the sensitivity of the environment. Upon ingestion, the character strings are parsed and normalized, often with preprocessing steps that include tokenization, encoding, and language filtering. These strings may contain a mix of plain terms, abbreviations, acronyms, or blended words that reflect the organization’s internal language conventions. Because these terms are native to the domain, they are likely to include proprietary, context-dependent, or non-standardized nomenclature that may not appear in external dictionaries. As such, receiving and handling this native domain data is a foundational step for systems designed to perform abbreviation expansion, semantic disambiguation, or internal metadata enrichment.

At step 404, process 400 (e.g., using one or more components described above) parses the native domain data to receive a native data record identifier. For example, the system may parse the native domain data to receive a native record identifier corresponding to a character string of the plurality of character strings. The system may parse the native domain data to receive a native record identifier by applying a lexical filtering and pattern recognition process across the plurality of character strings contained within the data. This parsing involves scanning the input data, e.g., whether structured or unstructured, for tokens or terms that meet specific criteria indicative of record identifiers, such as unusual capitalization, character length constraints, alphanumeric patterns, or the absence of common dictionary words. For instance, the system may use a reference word list to distinguish standard vocabulary from potential abbreviations, acronyms, or domain-specific shorthand. Any term not found in the reference list is flagged as a candidate native record identifier. The parser may also consider the structural placement of a character string, e.g., such as its appearance in column names, headings, or labels, to infer its role as a unique identifier. Additional heuristics, such as delimiter patterns (e.g., underscores or camelCase), prefix conventions, or frequency of use across datasets, may further refine the identification process. By leveraging these rules and context cues, the system isolates character strings that serve as native record identifiers, which are essential anchors for downstream expansion and disambiguation tasks.

At step 406, process 400 (e.g., using one or more components described above) generates a first prompt based on the native data record identifier. For example, the system may generate a first prompt, for a first model, based on the native record identifier and a context for the native record identifier. The system may generate a first prompt for a first model by combining the native record identifier with its associated contextual information in a structured and semantically rich format. Once a native record identifier is extracted, e.g., such as an abbreviation or acronym appearing in a column name or document, the system retrieves surrounding data that helps clarify the identifier’s meaning. This context may include a column description, neighboring metadata fields, or paragraphs from internal documents in which the identifier is embedded. The system then formats this information into a prompt designed to be consumed by a language model, using natural language instructions that ask the model to interpret or expand the identifier. For example, the prompt might include a field specifying the target abbreviation (e.g., “RL”), the broader term in which it appears (e.g., “AGG_SCORE_FOR_RL”), and a contextual sentence (e.g., “This column represents the aggregation score of risk level”). The prompt may also adopt a standardized structure, such as JSON, and incorporate few-shot examples to guide the model’s behavior. This carefully crafted prompt ensures that the model receives not only the identifier but also the semantic cues necessary to generate an accurate and domain-appropriate expansion.

In some embodiments, the system may generate the first prompt by determining a portion of the plurality of character strings corresponding to the character string and determining the context based on the portion. For example, the system may generate the first prompt by first determining a portion of the plurality of character strings that includes or surrounds the character string identified as the native record identifier. The system may apply a rule that eliminates entries where the expansion simply results from splitting the original term. Additionally or alternatively, this may involve scanning the native domain data to locate the specific context in which the character string appears, e.g., such as a column name, file label, log entry, or sentence fragment, and isolating a relevant segment that provides semantic cues about its intended meaning. Once this portion is identified, the system analyzes it to extract contextual information, such as adjacent descriptors, field definitions, or surrounding language that helps clarify how the character string functions within its environment. This extracted portion becomes the contextual foundation for prompt generation. The system then formats the native record identifier and its associated context into a structured input for a language model, ensuring the prompt captures both the identifier and the domain-specific cues that inform its interpretation. By grounding the prompt in a naturally occurring segment of character strings, the system ensures that the language model receives a realistic, context-aware input that supports accurate and relevant expansion of the identifier.

In some embodiments, the system may generate the first prompt by determining a metadata field name corresponding to the character string and determining the context based on the metadata field name. For example, the system may generate the first prompt by identifying a metadata field name that corresponds to the character string designated as the native record identifier and then using that metadata field name to derive contextual information. This process begins with the system parsing structured datasets or database schemas to locate the native record identifier within a metadata field, such as a column name, tag, or parameter label. Once the field containing the character string is identified, the system retrieves any descriptive metadata associated with that field, for example, a column description, tooltip, schema annotation, or documentation snippet. This metadata often provides a concise, human-readable explanation of the field’s purpose or content, offering critical context about how the native record identifier is used within the data environment. The system then composes a prompt that combines the native record identifier, the field name in which it resides, and the associated metadata description. For instance, if the character string “RL” appears in a field called “AGG_SCORE_FOR_RL” and the description reads “This column represents the aggregation score of risk level,” the system uses this information to frame the prompt in a structured format. This method ensures that the prompt sent to the language model captures both the identifier and its usage context, thereby enabling more accurate and semantically informed expansion.

In some embodiments, the system may generate the first prompt by determining a metadata field name corresponding to the character string and determining the context based on the metadata field name. For example, the system may generate the first prompt by first identifying a metadata field name that includes or is closely associated with the character string recognized as a native record identifier. This typically involves scanning structured datasets, e.g., such as databases, spreadsheets, or APIs, for field names that contain the target string, often embedded within compound labels (e.g., “AGG_SCORE_FOR_RL”). Once the relevant metadata field name is located, the system determines its surrounding context by retrieving additional metadata tied to that field, such as column descriptions, schema annotations, or data dictionary entries. These metadata sources frequently provide explanatory text that clarifies the field’s function, the meaning of its components, or how it is used within the broader system. The system then constructs a structured prompt by combining the native record identifier, the full metadata field name in which it appears, and the contextual metadata description. For example, the character string “RL” found within “AGG_SCORE_FOR_RL” may be paired with a column description like “This field represents the aggregation score for the risk level.” This information is assembled into a prompt template suitable for input into a language model, guiding the model to interpret or expand the abbreviation with precision based on domain-specific context.

At step 408, process 400 (e.g., using one or more components described above) generates a non-native data record identifier based on the first prompt. For example, the system may generate a non-native record identifier based on the first prompt, wherein the non-native record identifier corresponds to a potential expansion of the native record identifier. The system may generate a non-native record identifier by submitting the first prompt, e.g., constructed from a native record identifier and its corresponding context, to a language model that has been trained or fine-tuned to understand domain-specific abbreviation patterns. The prompt typically includes the native identifier (such as an acronym or abbreviation), the full metadata field in which it appears, and a contextual description that explains how the identifier is used or what it represents. By processing this prompt, the language model evaluates the semantic context and produces a likely full-form interpretation that is not currently present in the system’s native lexicon. This output is referred to as a non-native record identifier because it represents an external or inferred expansion, e.g., such as “Risk Level” for the native identifier “RL,” that was not explicitly defined in the original dataset but is inferred through reasoning and contextual alignment. The generated non-native identifier acts as a potential candidate for enriching the internal metadata vocabulary, bridging informal shorthand with standardized language. This process enables the system to intelligently surface meaningful expansions that enhance interpretability while maintaining alignment with domain semantics.

In some embodiments, the system may generate a non-encrypted computer network identifier by submitting the first prompt, e.g., comprising an encrypted computer network identifier and its contextual metadata, to a language model configured to interpret and expand domain-specific terminology. The first prompt provides the model with essential semantic cues, such as the identifier’s placement within a metadata field name and a corresponding description or usage context. Using this prompt, the language model analyzes the encrypted identifier, interprets its likely meaning based on the surrounding context, and generates a human-readable expansion that serves as a candidate non-encrypted computer network identifier. For instance, if the encrypted identifier “RL” appears in a field like “AGG_SCORE_FOR_RL” and is described as “the aggregation score for the risk level,” the model may infer that “RL” expands to “Risk Level.” This expanded term, e.g., now interpretable and semantically grounded, is returned by the system as a non-encrypted identifier, representing a meaningful and domain-relevant interpretation of the original obfuscated string. This process allows the system to bridge encrypted internal references with intelligible terminology, facilitating easier understanding, integration, and downstream processing.

At step 410, process 400 (e.g., using one or more components described above) compares the non-native data record identifier to a plurality of native data record identifiers. For example, the system may compare the non-native record identifier to a plurality of native record identifiers to generate a recommendation for the non-native record identifier, wherein the recommendation indicates whether the non-native record identifier corresponds to an expansion of the native record identifier. The system may compare the non-native record identifier to a plurality of native record identifiers by conducting a semantic similarity assessment and contextual alignment check across its existing internal vocabulary. Once a non-native record identifier is generated, e.g., based on a prompt containing a native identifier and its context, the system evaluates whether this candidate expansion already exists or closely resembles any entries in the set of known native record identifiers. This comparison may involve embedding-based similarity scoring, string matching algorithms, or ontology-based lookups to determine if the non-native term maps to or conflicts with previously observed native identifiers. The system may also consider how frequently the proposed expansion appears in similar contexts across the dataset, reinforcing its plausibility. Based on this analysis, the system generates a recommendation indicating whether the non-native identifier should be accepted as a valid expansion of the native identifier. This recommendation may include a confidence score or label such as “valid,” “ambiguous,” or “rejected,” and serves as a decision point for integrating the expansion into a reference table or flagging it for further review. By systematically comparing the candidate term against internal records, the system ensures consistency, prevents semantic duplication, and supports high-quality metadata enrichment.

In some embodiments, the system may compare the non-native record identifier to the plurality of native record identifiers to generate the recommendation for the non-native record identifier by determining whether to filter out the non-native record identifier based on comparing the non-native record identifier to the plurality of native record identifiers and determining the recommendation based on determining whether to filter out the non-native record identifier. For example, the system may compare the non-native record identifier to a plurality of native record identifiers by executing a filtering process that evaluates whether the candidate expansion should be accepted or discarded. This begins with determining whether the non-native record identifier, e.g., generated from a prompt using a native identifier and its context, matches or closely resembles any of the existing native record identifiers in the system. The comparison may include exact string matches, fuzzy matching techniques such as Levenshtein distance, and semantic similarity calculations using vector embeddings. If the system finds that the non-native identifier already exists in the native set, or that it is a trivial transformation of an existing term (e.g., a simple token split or minor variation), it may decide to filter it out to avoid redundancy or semantic noise. Alternatively, if the expansion appears novel, meaningful, and not conflicting with established identifiers, it proceeds past the filter. Based on this filtering decision, the system generates a recommendation indicating whether the non-native record identifier is a valid and useful expansion. If filtered out, the recommendation might state that the expansion is unnecessary, duplicative, or semantically weak. If retained, the recommendation affirms its value for enriching the internal lexicon. This structured filtering step ensures that only high-quality, distinct, and contextually appropriate expansions are incorporated into the system.

In some embodiments, the system may determine whether to filter out the non-native record identifier by parsing the native record identifier into a first portion and a second portion and comparing the non-native record identifier to the first portion or the second portion to determine whether to filter out the non-native record identifier based on the non-native record identifier corresponding to either the first portion or the second portion. For example, the system may determine whether to filter out a non-native record identifier by first parsing the associated native record identifier into a first portion and a second portion, typically by identifying delimiters, naming conventions, or structural patterns within the identifier. For example, a native identifier such as “AGG_SCORE” might be split into the first portion “AGG” and the second portion “SCORE.” The system then compares the non-native record identifier, e.g., previously generated as a possible expansion, to each of these parsed components. If the non-native identifier matches or closely resembles either portion, the system may conclude that the expansion is redundant or semantically trivial and thus elect to filter it out. This prevents unnecessary inclusion of expansions that simply restate or replicate parts of the original term without adding meaningful interpretation. For instance, if the system generates “Aggregation” as the expansion of “AGG” and it already appears implicitly in “AGG_SCORE,” the system may consider the expansion insufficiently informative and reject it. This parsing-based filtering mechanism ensures that only contextually rich and non-redundant expansions are retained, thereby enhancing the precision and usefulness of the system’s identifier expansion framework.

In some embodiments, the system may determine whether to filter out the non-native record identifier by determining an alternative character string corresponding to the non-native record identifier and comparing the alternative character string to one or more of a plurality of native record identifiers to determine whether to filter out the non-native record identifier based on the non-native record identifier corresponding to the alternative character string. For example, the system may determine whether to filter out a non-native record identifier by first generating an alternative character string that represents a normalized or rephrased version of the non-native identifier. This alternative character string may be derived through common transformations such as lowercasing, removing stop words, stemming, or replacing synonyms, and is intended to capture semantic equivalence or syntactic variation. Once this alternative string is produced, the system compares it against one or more of the native record identifiers in its internal vocabulary. If the alternative character string matches or closely aligns with an existing native identifier, e.g., either exactly or through fuzzy matching techniques, the system interprets this as evidence that the non-native identifier is already implicitly present in the dataset. In such cases, the expansion is deemed redundant, and the system filters it out to avoid duplication or confusion. For example, if the non-native identifier “Risk Level” maps to an alternative string “risklevel,” which is already used as a native identifier elsewhere in the system, the expansion may be rejected. This comparison-based filtering process ensures that only novel, non-duplicative, and semantically distinct expansions are retained, preserving the integrity and usefulness of the expanded identifier set.

In some embodiments, the system may determine whether to filter out the non-native record identifier by determining an edit distance for the non-native record identifier, wherein the edit distance represents a minimum number of single character needed to change the non-native record identifier into the native record identifier and comparing the edit distance to a threshold edit distance to determine whether to filter out the non-native record identifier. For example, the system may determine whether to filter out a non-native record identifier by calculating an edit distance between the non-native identifier and one or more native record identifiers. The edit distance represents the minimum number of single-character operations, e.g., such as insertions, deletions, or substitutions, required to transform the non-native identifier into a native one. This metric provides a quantitative measure of similarity between the two terms. After computing the edit distance, the system compares it against a predefined threshold value. If the edit distance falls below or equals the threshold, indicating a high degree of similarity, the system may determine that the non-native identifier is too close to an existing native identifier and therefore redundant or potentially duplicative. In such cases, the expansion is filtered out to maintain the distinctiveness and clarity of the identifier lexicon. For instance, if the non-native identifier is “AcctNum” and a native identifier “ActNum” already exists, a small edit distance (e.g., one character change) may trigger rejection. This approach helps the system avoid adding expansions that are likely the result of typographical variations or superficial modifications, thereby improving the precision of metadata enrichment.

In some embodiments, the system may compare the non-native record identifier to the plurality of native record identifiers to generate the recommendation for the non-native record identifier by determining not to filter out the non-native record identifier, and, in response to determining not to filter out the non-native record identifier, generating a second prompt, for a second model, based on the non-native record identifier to determine an ambiguity of the non-native record identifier. For example, the system may compare the non-native record identifier to a plurality of native record identifiers to determine whether the candidate expansion should be retained or filtered out. This comparison involves evaluating factors such as string similarity, semantic redundancy, and contextual overlap with known identifiers. If, after applying these checks, the system determines that the non-native record identifier does not duplicate or conflict with any existing native identifier, e.g., based on metrics like edit distance thresholds, lexical pattern matching, or normalized variant detection, it concludes that the candidate should not be filtered out. In response to this determination, the system proceeds to a disambiguation phase by generating a second prompt tailored for a second model, typically a language model serving as a semantic evaluator or “LLM-as-a-Judge.” This second prompt incorporates the non-native record identifier along with multiple potential meanings or contexts in which it may appear. The purpose of this prompt is to assess whether the non-native identifier is ambiguous, e.g., that is, whether it may refer to more than one concept depending on the usage scenario. The second model then analyzes the input to either confirm a consistent meaning or identify divergent interpretations tied to different contextual keywords. This enables the system to generate a precise recommendation regarding the semantic clarity and applicability of the non-native record identifier before integrating it into the broader metadata framework.

In some embodiments, the system may determine the ambiguity of the non-native record identifier by determining an output variability of the second model and comparing the output variability to a threshold output variability. For example, the system may determine the ambiguity of a non-native record identifier by analyzing the output variability of a second model, e.g., typically a language model tasked with evaluating semantic consistency, and comparing that variability to a predefined threshold. To do this, the system generates multiple inferences from the second model using slightly altered or repeated versions of the same prompt, each centered around the non-native identifier and its possible contexts. If the model consistently returns the same expansion or interpretation, the output variability is low, suggesting that the identifier is unambiguous and semantically stable. However, if the model produces multiple distinct expansions across these runs, e.g., such as interpreting “LTD” alternately as “Life To Date,” “Long-Term Disability,” and “Limited,” the system quantifies this as high output variability. It then compares the measured variability to a threshold value that defines acceptable semantic divergence. If the variability exceeds the threshold, the system flags the identifier as ambiguous; if it remains below the threshold, the identifier is considered unambiguous and suitable for inclusion. This approach enables the system to assess ambiguity not merely by static definitions but by measuring the inherent uncertainty or inconsistency in model interpretations, leading to more informed and context-aware metadata recommendations.

In some embodiments, the system may determine the ambiguity of the non-native record identifier by determining a level of detail in the second prompt and comparing the level of detail to a threshold level of detail. For example, the system may determine the ambiguity of a non-native record identifier by evaluating the level of detail present in the second prompt and comparing it to a predefined threshold level of detail. The second prompt, generated to assess the meaning of the non-native identifier, typically includes contextual information such as surrounding metadata, usage examples, or descriptions from relevant data fields. The system analyzes this prompt to quantify the richness and specificity of the context, e.g., such as the presence of explanatory phrases, domain-specific terms, or multiple clarifying keywords, which collectively define the level of detail. If the prompt contains a high level of detail, the system may infer that the identifier’s meaning is likely to be well-supported and unambiguous. Conversely, if the prompt is sparse or vague, e.g., lacking concrete examples or precise descriptors, the system considers the context insufficient to disambiguate the identifier with confidence. By comparing the assessed level of detail to a minimum threshold, the system determines whether the contextual information is adequate to support a clear and consistent interpretation. If the level of detail falls below the threshold, the non-native identifier may be flagged as ambiguous or underdefined; if it meets or exceeds the threshold, the identifier is considered to have sufficient context for reliable expansion. This comparison ensures that only contextually grounded identifiers are approved, improving semantic accuracy in downstream metadata applications.

In some embodiments, the system may determine the ambiguity of the non-native record identifier by determining whether the non-native record identifier comprises multiple contexts and annotating the non-native record identifier based on determining that the non-native record identifier comprises the multiple contexts. For example, the system may determine the ambiguity of a non-native record identifier by analyzing whether the identifier is associated with multiple distinct contexts within the dataset. To do this, the system examines all occurrences of the non-native identifier across various metadata fields, documents, or schema descriptions and extracts the contextual information surrounding each instance. It then compares these contexts to determine if they reflect different semantic interpretations. For example, the identifier “LTD” might appear in financial records as “Long Term Debt,” in HR documents as “Long-Term Disability,” and in corporate names as “Limited.” If the system detects that the identifier is used with divergent meanings across these contexts, it classifies the identifier as ambiguous due to polysemy. In response, the system annotates the non-native record identifier with metadata that captures each associated meaning, possibly tagging it with context-specific keywords or usage domains. This annotation enables downstream applications and users to disambiguate the identifier based on context, ensuring more accurate interpretation and integration. By systematically identifying and marking multi-context identifiers, the system enhances semantic transparency and reduces the risk of misinterpretation in automated processing and human analysis.

At step 412, process 400 (e.g., using one or more components described above) generates a recommendation for the non-native data record identifier. For example, the system may generate for display, on a user interface, the recommendation. The system may generate for display, on a user interface, the recommendation for a non-native record identifier by formatting the output of its analysis into a structured, user-readable format that communicates the result of the identifier expansion and evaluation process. After the system has determined whether the non-native record identifier is valid, ambiguous, or should be filtered out, e.g., based on comparisons with native identifiers, contextual disambiguation, and ambiguity checks, it constructs a recommendation object that includes the original native identifier, the proposed expansion, a confidence score or decision label (e.g., “Accepted,” “Ambiguous,” “Rejected”), and any supporting metadata such as contextual keywords, frequency metrics, or examples of use. This information is then rendered on the user interface in a clear and accessible layout, such as within a table, card, or modal window. The display may include interactive elements that allow users to explore alternative expansions, review ambiguity explanations, or provide feedback. By presenting the recommendation in this structured and transparent way, the system enables human reviewers to validate the expansion, understand the reasoning behind the recommendation, and make informed decisions about whether to accept, revise, or reject the identifier for integration into the domain lexicon.

Alternatively or additionally, the system may define and/or update a table that records mappings between a network identifier (e.g., an acronym, abbreviation, code, or short label) and its expansion by maintaining a structured store of candidate and approved relationships. For example, the table may include columns for the native network identifier, the recommended expansion (non-native identifier), a canonical identifier (if the expansion maps to a controlled vocabulary), context attributes used to disambiguate (such as domain, record type, source system, language, and tenant), confidence or verification score, evidence (sample text snippets, model outputs, similarity metrics), provenance (model/version, prompt template, timestamp), and a status field (e.g., proposed, approved, rejected, deprecated) with an effective date range for versioning. When the system encounters a new identifier or a new context, it generates one or more candidate expansions, validates them, and then inserts a new row if no suitable mapping exists, or updates an existing row by adjusting the expansion, confidence, and metadata, optionally keeping historical rows for auditability. Updates may be performed automatically when confidence exceeds a threshold, or routed through human review workflows that approve or reject the recommendation; the system may then promote approved mappings to “active,” demote outdated mappings, and periodically re-score entries as models, ontologies, or usage patterns change.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for record identifier expansion based on non-native record identifiers.
2. The method of any one of the preceding embodiments, further comprising: receiving native domain data, wherein the native domain data comprise a plurality of character strings; parsing the native domain data to receive a native record identifier corresponding to a character string of the plurality of character strings; generating a first prompt, for a first model, based on the native record identifier and a context for the native record identifier; generating a non-native record identifier based on the first prompt, wherein the non-native record identifier corresponds to a potential expansion of the native record identifier; comparing the non-native record identifier to a plurality of native record identifiers to generate a recommendation for the non-native record identifier, wherein the recommendation indicates whether the non-native record identifier corresponds to an expansion of the native record identifier; and generating for display, on a user interface, the recommendation.
3. The method of any one of the preceding embodiments, wherein comparing the non-native record identifier to the plurality of native record identifiers to generate the recommendation for the non-native record identifier further comprises: determining whether to filter out the non-native record identifier based on comparing the non-native record identifier to the plurality of native record identifiers; and determining the recommendation based on determining whether to filter out the non-native record identifier.
4. The method of any one of the preceding embodiments, wherein determining whether to filter out the non-native record identifier further comprises: parsing the native record identifier into a first portion and a second portion; and comparing the non-native record identifier to the first portion or the second portion to determine whether to filter out the non-native record identifier based on the non-native record identifier corresponding to either the first portion or the second portion.
5. The method of any one of the preceding embodiments, wherein determining whether to filter out the non-native record identifier further comprises: determining an alternative character string corresponding to the non-native record identifier; and comparing the alternative character string to one or more of a plurality of native record identifiers to determine whether to filter out the non-native record identifier based on the non-native record identifier corresponding to the alternative character string.
6. The method of any one of the preceding embodiments, wherein determining whether to filter out the non-native record identifier further comprises: determining an edit distance for the non-native record identifier, wherein the edit distance represents a minimum number of single character needed to change the non-native record identifier into the native record identifier; and comparing the edit distance to a threshold edit distance to determine whether to filter out the non-native record identifier.
7. The method of any one of the preceding embodiments, wherein comparing the non-native record identifier to the plurality of native record identifiers to generate the recommendation for the non-native record identifier further comprises: determining not to filter out the non-native record identifier; and in response to determining not to filter out the non-native record identifier, generating a second prompt, for a second model, based on the non-native record identifier to determine an ambiguity of the non-native record identifier.
8. The method of any one of the preceding embodiments, wherein determining the ambiguity of the non-native record identifier further comprises: determining an output variability of the second model; and comparing the output variability to a threshold output variability.
9. The method of any one of the preceding embodiments, wherein determining the ambiguity of the non-native record identifier further comprises: determining a level of detail in the second prompt; and comparing the level of detail to a threshold level of detail.
10. The method of any one of the preceding embodiments, wherein determining the ambiguity of the non-native record identifier further comprises: determining whether the non-native record identifier comprises multiple contexts; and annotating the non-native record identifier based on determining that the non-native record identifier comprises the multiple contexts.
11. The method of any one of the preceding embodiments, wherein generating the first prompt further comprises: determining a portion of the plurality of character strings corresponding to the character string; and determining the context based on the portion.
12. The method of any one of the preceding embodiments, wherein generating the first prompt further comprises: determining a metadata field name corresponding to the character string; and determining the context based on the metadata field name.
13. The method of any one of the preceding embodiments, wherein generating the first prompt further comprises: determining a metadata field name corresponding to the character string; and determining the context based on the metadata field name.
14. The method of any one of the preceding embodiments, wherein the potential expansion of the native record identifier does not correspond to an expansion in the native domain data.
15. One or more non-transitory, computer-readable mediums storing instructions that, when executed by a data processing apparatus, cause the data processing apparatus to perform operations comprising those of any of embodiments 1–14.
16. A system comprising one or more processors; and memory storing instructions that, when executed by the processors, cause the processors to effectuate operations comprising those of any of embodiments 1–14.
17. A system comprising means for performing any of embodiments 1–14.

What is claimed is:

1. A system for secured archiving and retrieval in mixed-domain computer networks, the system comprising:
one or more processors; and
one or more non-transitory, computer-readable media, comprising instructions that, when executed by the one or more processors, cause operations comprising:
accessing secured computer network domains, wherein the secured computer network domains comprise a plurality of encrypted character strings;
parsing the secured computer network domains to receive an encrypted computer network identifier corresponding to a text string of the plurality of encrypted character strings;
generating a first prompt, for a first model, based on the encrypted computer network identifier and a context for the encrypted computer network identifier;
generating a non-encrypted computer network identifier based on the first prompt, wherein the non-encrypted computer network identifier corresponds to a potential expansion of the encrypted computer network identifier;
comparing the non-encrypted computer network identifier to a plurality of encrypted computer network identifiers to determine whether to filter out the non-encrypted computer network identifier;
in response to determining not to filter out the non-encrypted computer network identifier, generating a second prompt, for a second model, based on the non-encrypted computer network identifier to determine an ambiguity of the non-encrypted computer network identifier, the second model being different from the first model; and
generating a recommendation for the non-encrypted computer network identifier based on the ambiguity, wherein the recommendation indicates whether the non-encrypted computer network identifier corresponds to an expansion of the encrypted computer network identifier.

2. A method for record identifier expansion based on non-native record identifiers, the method comprising:
receiving native domain data, wherein the native domain data comprise a plurality of character strings;
parsing the native domain data to receive a native record identifier corresponding to a character string of the plurality of character strings;
generating a first prompt, for a first model, based on the native record identifier and a context for the native record identifier;
generating a non-native record identifier based on the first prompt, wherein the non-native record identifier corresponds to a potential expansion of the native record identifier; and
comparing the non-native record identifier to a plurality of native record identifiers to generate a recommendation for the non-native record identifier, wherein the recommendation indicates whether the non-native record identifier corresponds to an expansion of the native record identifier.

3. The method of claim 2, wherein comparing the non-native record identifier to the plurality of native record identifiers to generate the recommendation for the non-native record identifier further comprises:
determining whether to filter out the non-native record identifier based on comparing the non-native record identifier to the plurality of native record identifiers; and
determining the recommendation based on determining whether to filter out the non-native record identifier.

4. The method of claim 3, wherein determining whether to filter out the non-native record identifier further comprises:
parsing the native record identifier into a first portion and a second portion; and
comparing the non-native record identifier to the first portion or the second portion to determine whether to filter out the non-native record identifier based on the non-native record identifier corresponding to either the first portion or the second portion.

5. The method of claim 3, wherein determining whether to filter out the non-native record identifier further comprises:
determining an alternative character string corresponding to the non-native record identifier; and
comparing the alternative character string to one or more of the plurality of native record identifiers to determine whether to filter out the non-native record identifier based on the non-native record identifier corresponding to the alternative character string.

6. The method of claim 3, wherein determining whether to filter out the non-native record identifier further comprises:
determining an edit distance for the non-native record identifier, wherein the edit distance represents a minimum number of single character needed to change the non-native record identifier into the native record identifier; and
comparing the edit distance to a threshold edit distance to determine whether to filter out the non-native record identifier.

7. The method of claim 3, wherein comparing the non-native record identifier to the plurality of native record identifiers to generate the recommendation for the non-native record identifier further comprises:
determining not to filter out the non-native record identifier; and
in response to determining not to filter out the non-native record identifier, generating a second prompt, for a second model, based on the non-native record identifier to determine an ambiguity of the non-native record identifier.

8. The method of claim 7, wherein determining the ambiguity of the non-native record identifier further comprises:
determining an output variability of the second model; and
comparing the output variability to a threshold output variability.

9. The method of claim 7, wherein determining the ambiguity of the non-native record identifier further comprises:
determining a level of detail in the second prompt; and
comparing the level of detail to a threshold level of detail.

10. The method of claim 7, wherein determining the ambiguity of the non-native record identifier further comprises:
determining whether the non-native record identifier comprises multiple contexts; and
annotating the non-native record identifier based on determining that the non-native record identifier comprises the multiple contexts.

11. The method of claim 2, wherein generating the first prompt further comprises:
determining a portion of the plurality of character strings corresponding to the character string; and
determining the context based on the portion.

12. The method of claim 2, wherein generating the first prompt further comprises:
determining a metadata field name corresponding to the character string; and
determining the context based on the metadata field name.

13. The method of claim 2, wherein generating the first prompt further comprises:
determining a metadata field name corresponding to the character string; and
determining the context based on the metadata field name.

14. The method of claim 2, wherein the potential expansion of the native record identifier does not correspond to an expansion in the native domain data.

15. One or more non-transitory, computer-readable media, comprising instructions that, when executed by one or more processors, cause operations comprising:
generating a first prompt, for a first model, based on a native record identifier and a context for the native record identifier, wherein the native record identifier corresponds to a character string of a plurality of character strings from a native domain data;
generating a non-native record identifier based on the first prompt, wherein the non-native record identifier corresponds to a potential expansion of the native record identifier;
comparing the non-native record identifier to a plurality of native record identifiers to generate a recommendation for the non-native record identifier, wherein the recommendation indicates whether the non-native record identifier corresponds to an expansion of the native record identifier; and
generating for display, on a user interface, the recommendation.

16. The one or more non-transitory, computer-readable media of claim 14, wherein comparing the non-native record identifier to the plurality of native record identifiers to generate the recommendation for the non-native record identifier further comprises:
determining whether to filter out the non-native record identifier based on comparing the non-native record identifier to the plurality of native record identifiers; and
determining the recommendation based on determining whether to filter out the non-native record identifier.

17. The one or more non-transitory, computer-readable media of claim 15, wherein determining whether to filter out the non-native record identifier further comprises:
parsing the native record identifier into a first portion and a second portion; and
comparing the non-native record identifier to the first portion or the second portion to determine whether to filter out the non-native record identifier based on the non-native record identifier corresponding to either the first portion or the second portion.

18. The one or more non-transitory, computer-readable media of claim 15, wherein determining whether to filter out the non-native record identifier further comprises:
determining an alternative character string corresponding to the non-native record identifier; and
comparing the alternative character string to one or more of the plurality of native record identifiers to determine whether to filter out the non-native record identifier based on the non-native record identifier corresponding to the alternative character string.

19. The one or more non-transitory, computer-readable media of claim 15, wherein determining whether to filter out the non-native record identifier further comprises:
determining an edit distance for the non-native record identifier, wherein the edit distance represents a minimum number of single-character needed to change the non-native record identifier into the native record identifier; and
comparing the edit distance to a threshold edit distance to determine whether to filter out the non-native record identifier.

20. The one or more non-transitory, computer-readable media of claim 15, wherein comparing the non-native record identifier to the plurality of native record identifiers to generate the recommendation for the non-native record identifier further comprises:
determining not to filter out the non-native record identifier; and
in response to determining not to filter out the non-native record identifier, generating a second prompt, for a second model, based on the non-native record identifier to determine an ambiguity of the non-native record identifier.
